(19) United States
(12) Patent Application Publication
(10) Pub. No.: US 2021/0004769 A1
(43) Pub. Date: Jan. 7, 2021

(54) AUTOMATED EVENT COORDINATION

(71) Applicant: Migojo Technologies, LLC, Lehi, UT (US)

(72) Inventors: Michael Crismon McVey, Pleasant Grove, UT (US); Douglas Grant Marriott, JR., Saratoga Springs, UT (US)

(73) Assignee: Migojo Technologies, LLC, Lehi, UT (US)

(21) Appl. No.: 16/503,436

(22) Filed: Jul. 3, 2019

(51) Int. Cl. G06Q 10/10; H04L 12/18

(52) U.S. Cl. CPC G06Q 10/1093; H04L 12/1818

(57) ABSTRACT

Systems and methods for automated calendar coordination based on predictive modeling are described. The systems and methods may provide for receiving availability information for a plurality of attendees, generating a plurality of candidate time periods based on the availability information, ranking the plurality of candidate time periods using a predictive model, selecting a preferred time period based on the ranking of the plurality of candidate time periods, and generating a calendar event based on the preferred time period.

### BACKGROUND

The following relates generally to calendar coordination, and more specifically to automated calendar coordination based on predictive modeling.

A calendar is a system used to organize personal, business, commercial, administrative, or social time periods into manageable time slots with a predetermined time and date. A schedule uses the calendar system to organize a list of tasks, actions, or events in a chronological order in which such items are intended to take place. Schedules are an important aspect to the arrangement of deadlines or meetings and can be useful in planning long-term or short-term events. Various computerized calendaring systems exist that facilitate the creation and management of calendar events.

In the fast paced, often busy, setting of modern businesses or extracurricular activities, there is significant time and effort needed to organize meeting times for multiple people in the best possible timeframe. Therefore, there is a need in the art for more efficient ways of scheduling calendar events.

### SUMMARY

Techniques are described for automating the coordination and scheduling of calendar meetings. Specifically, the systems and methods described herein provide for identifying a meeting time based on attendee availability, using advanced data analytics of scheduling behaviors for specific attendee profiles, and predictive models indicating the most likely date and time that will be acceptable to all attendees; and then automatically placing the meeting time on all attendee calendars.

A method, apparatus, non-transitory computer readable medium, and system for automated calendar coordination based on predictive modeling are described. The method, apparatus, non-transitory computer readable medium, and system may provide for receiving availability information for a plurality of attendees, generating a plurality of candidate time periods based on the availability information, ranking the plurality of candidate time periods using a predictive model, selecting a preferred time period based on the ranking of the plurality of candidate time periods, and generating a calendar event based on the preferred time period.

A method, apparatus, non-transitory computer readable medium, and system for automated calendar coordination based on predictive modeling are described. The method, apparatus, non-transitory computer readable medium, and system may provide for identifying a plurality of attendees, determining that calendar access is authorized for each of the plurality of attendees, enabling an automatic time selection mode based on the determination that calendar access is authorized, receiving availability information for each of the plurality of attendees based on the calendar access, generating a calendar event using a predictive model based on the availability information, and automatically adding the calendar event to a calendar for each of the plurality of attendees based on the automatic time selection mode.

### BRIEF DESCRIPTION OF THE DRAWINGS

FIG. 1 shows an example of a system for automated event coordination in accordance with aspects of the present disclosure.

FIG. 2 shows an example of a server in accordance with aspects of the present disclosure.

FIGS. 3 through 6 show examples of a process for automated calendar coordination based on predictive modeling in accordance with aspects of the present disclosure.

### DETAILED DESCRIPTION

Coordinating calendar events between multiple people can be a complex and time consuming task, even with the use of computerized calendar applications. The coordination problems can be compounded by the fact that different people may use different calendar platforms, and may wish to keep their calendar information private from others with whom they are coordinating an event.

Embodiments of the present disclosure provide for automated calendar event creation that facilitates coordination between multiple people, while maintaining data security and privacy between individuals from different organizations. Attendees for an event may be selected, and availability information may be gathered for each attendee. In some cases, a coordinator from one or more additional organizations may add attendees from that organization, and in some cases, provide authorization to access the availability information of those attendees.

Candidate time periods may be selected based on algorithmic rules using the availability information. Then, a predictive model may be used to rank the candidate time periods and select a time period for the event that has the highest likelihood of being suitable for the set of attendees. In some cases, some attendees may be listed as optional, and the predictive model may ignore or discount their availability information to focus on the required attendees. Once a time period is selected, a calendar event may be created and automatically added to the calendars of the selected attendees. Attendance feedback may be gathered to further update the predictive model and improve the accuracy of future time period selection.

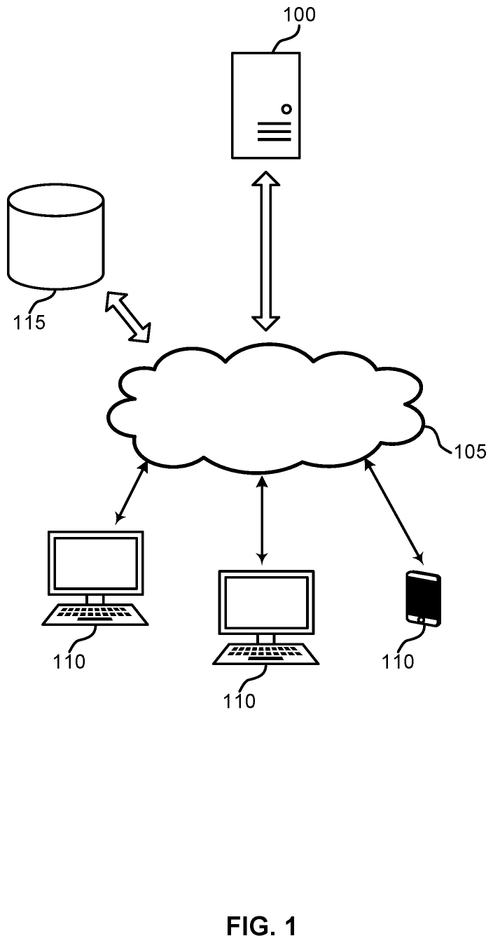

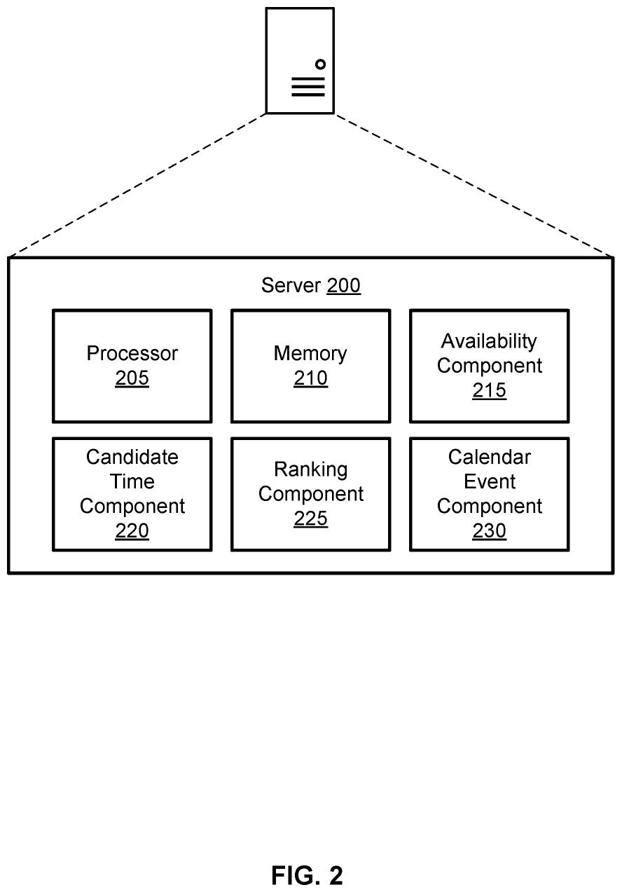

FIG. 1 shows an example of a system for automated event coordination in accordance with aspects of the present disclosure. The system may include a server 100, a network 105, user terminals 110, and availability database 115. Server 100 may be an example of, or include aspects of, the corresponding element or elements described with reference to FIG. 2. A terminal 110 may be a personal computer, laptop computer, personal assistant, mobile device, or any other suitable processing apparatus.

One or more users may initiate the creation of a calendar event using a terminal 110. The server 100 may request availability information for a plurality of attendees from the availability database 115 (e.g., a cloud-based calendar platform) via the network 105. The server 100 then receives availability information for the plurality of attendees and generates a plurality of candidate time periods based on the availability information. A predictive model is then used to rank the plurality of candidate time periods. A preferred time period is selected based on the ranking, after which the server 100 then generates a calendar event based on the preferred time period. A calendar event is then automatically placed on the calendar of each of the plurality of attendees.

By sending availability information to the server 100, calendar events may be coordinated without sharing private information between individuals that do not have full access to each other's calendars. In some cases, users or organizations may provide authorization to the system (i.e., the system operating on server 100) to access the availability information.

If some of the attendees are from a different organization from the initiator of the event creation process, a coordinator from the external organization may select additional attendees from their organization to add to the list of attendees before the calendar event is created (i.e., an email or another message may be sent to the external coordinator requesting that they add additional attendees).

In one embodiment, users may create a calendar event by selecting a list of attendees and then performing a single-click event creation procedure that automatically initiates the gathering of availability information, generation of candidate time periods, selection of the most appropriate time period, and placement of a corresponding calendar event on a calendar for each of the attendees.

FIG. 2 shows an example of a server 200 in accordance with aspects of the present disclosure. Server 200 may include processor 205, memory 210, availability component 215, candidate time component 220, ranking component 225, and calendar event component 230. Server 200 may be an example of, or include aspects of, the corresponding element or elements described with reference to FIG. 1.

A processor 205 may include an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor 205 may be configured to operate a memory array using a memory controller. In other cases, a memory controller may be integrated into processor 205. The processor 205 may be configured to execute computer-readable instructions stored in a memory 210 to perform various functions.

A computer memory 210 may store information for various programs and applications on a computing device. For example, the storage may include data for running an operating system. The memory 210 may include both volatile memory and non-volatile memory. Volatile memory may include random access memory (RAM), and non-volatile memory may include read-only memory (ROM), flash memory, electrically erasable programmable read-only memory (EEPROM), digital tape, a hard disk drive (HDD), and a solid-state drive (SSD). Memory 210 may include any combination of readable and/or writable volatile memories and/or non-volatile memories, along with other possible storage devices.

In some embodiments, the server 200 may use an artificial neural network (ANN) to perform the ranking of candidate time periods. An ANN may be a hardware or a software component that includes several connected nodes (a.k.a., artificial neurons), which may be seen as loosely corresponding to the neurons in a human brain. Each connection, or edge, may transmit a signal from one node to another (like the physical synapses in a brain). When a node receives a signal, it can process the signal and then transmit the processed signal to other connected nodes. In some cases, the signals between nodes comprise real numbers, and the output of each node may be computed by a function of the sum of its inputs. Each node and edge may be associated with one or more node weights that determine how the signal is processed and transmitted.

Training data for the predictive model may include meeting time information, user profile information and availability information as inputs, along with whether the resulting meeting time was acceptable as a target. During the training process, these weights may be adjusted to improve the accuracy of the result (i.e., by minimizing a loss function which corresponds in some way to the difference between the current result and the target result). The weight of an edge may increase or decrease the strength of the signal transmitted between nodes. In some cases, nodes may have a threshold below which a signal is not transmitted at all. The nodes may also be aggregated into layers. Different layers may perform different transformations on their inputs. The initial layer may be known as the input layer and the last layer may be known as the output layer. In some cases, signals may traverse certain layers multiple times.

Availability component 215 may receive availability information for a set of attendees. Availability component 215 may also identify the set of attendees based on input from a meeting initiator. Availability component 215 may also identify a calendar platform of the attendees. Availability component 215 may also query the calendar platform, where at least a portion of the availability information is received in response to the query. Availability component 215 may also determine that at least one of the attendees is associated with an external organization. Availability component 215 may also identify an organization coordinator for the external organization. Availability component 215 may also transmit coordination information to the organization coordinator. Availability component 215 may also receive input from the organization coordinator in response to the coordination information, where the availability information is received based on the input. In some examples, at least one of the attendees is identified based on the input from the organization coordinator. In some examples, the input from the organization coordinator includes authorization information for accessing calendar information for at least one of the attendees.

According to one embodiment, availability component 215 may identify a set of attendees. Availability component 215 may also determine that calendar access is authorized for each of the set of attendees. Availability component 215 may also enable an automatic time selection mode based on the determination that calendar access is authorized. Availability component 215 may also receive availability information for each of the set of attendees based on the calendar access. In some examples, the determination that calendar access is authorized is based on the set of attendees belonging to a same organization. Availability component 215 may also transmit a calendar connect request. Availability component 215 may also receive calendar access for at least one of the set of attendees based on the calendar connect request.

Candidate time component 220 may generate a set of candidate time periods based on the availability information. Candidate time component 220 may also identify a set of scheduling rules including time of day rules, day of week rules, holiday rules, seasonality rules, a future time threshold, or any combination thereof, where the candidate time periods are generated based on the set of scheduling rules.

Ranking component 225 may rank the set of candidate time periods using a predictive model, as well as identifying a user profile for each of the set of attendees. Ranking component 225 may also generate an input for the predictive model based on the user profiles then score each of the candidate time periods based on each of the user profiles then generate an aggregate score for each of the time periods based on the scoring. In some examples, the user profile for each of the set of attendees includes personal information, company information, a scheduling history, a hold rate history, a meeting acceptance history, a position, a gender, a time of year, age information, demographic information, weather information, or any combination thereof.

In some embodiments, ranking component 225 may also receive meeting acceptance feedback in response to the generated calendar event which may update the predictive model based on the meeting acceptance feedback. Ranking component 225 may also identify training data based on historical meeting acceptance data, then train the predictive model based on the meeting acceptance data, where the predictive model includes a machine learning model. Ranking component 225 may also determine that at least one of the attendees is an optional attendee, where generating the set of candidate time periods or ranking the set of time periods is based on the determination.

Calendar event component 230 may generate a calendar event based on the preferred time period. Calendar event component 230 may also automatically place the calendar event on a calendar of each of the set of attendees. Calendar event component 230 may also receive feedback for the calendar event based on the placement. Calendar event component 230 may also select an alternative time period based on the feedback and the ranking. Calendar event component 230 may also update the calendar event based on the alternative time period.

Calendar event component 230 may generate a calendar event using a predictive model based on the availability information. Calendar event component 230 may also automatically add the calendar event to a calendar for each of the set of attendees based on the automatic time selection mode.

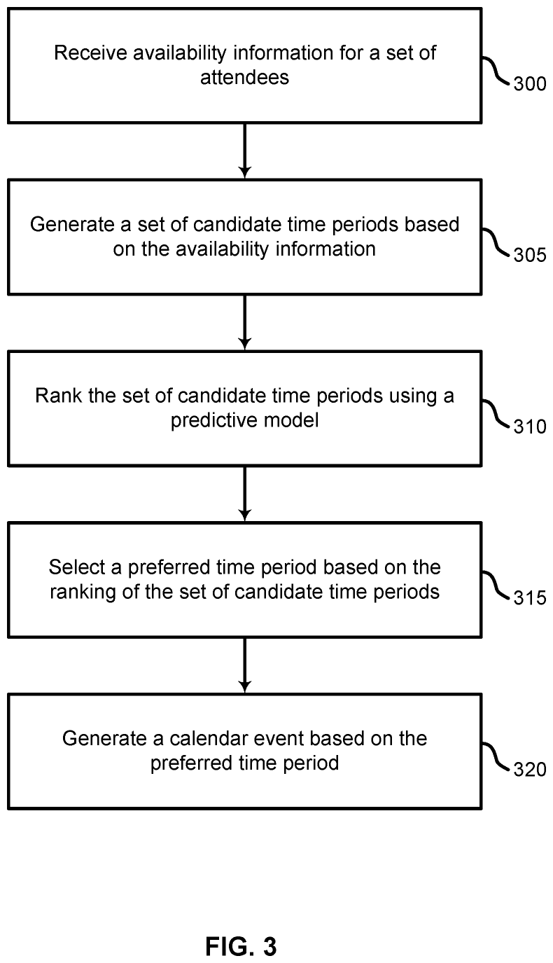

FIG. 3 shows an example of a process for automated calendar coordination based on predictive modeling in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 300, the system receives availability information for a set of attendees. In some cases, the operations of this step may refer to, or be performed by, an availability component as described with reference to FIG. 2.

At step 305, the system generates a set of candidate time periods based on the availability information. In some cases, the operations of this step may refer to, or be performed by, a candidate time component as described with reference to FIG. 2.

At step 310, the system ranks the set of candidate time periods using a predictive model. In some cases, the operations of this step may refer to, or be performed by, a ranking component as described with reference to FIG. 2.

At step 315, the system selects a preferred time period based on the ranking of the set of candidate time periods. In some cases, the operations of this step may refer to, or be performed by, a ranking component as described with reference to FIG. 2.

At step 320, the system generates a calendar event based on the preferred time period. In some cases, the operations of this step may refer to, or be performed by, a calendar event component as described with reference to FIG. 2.

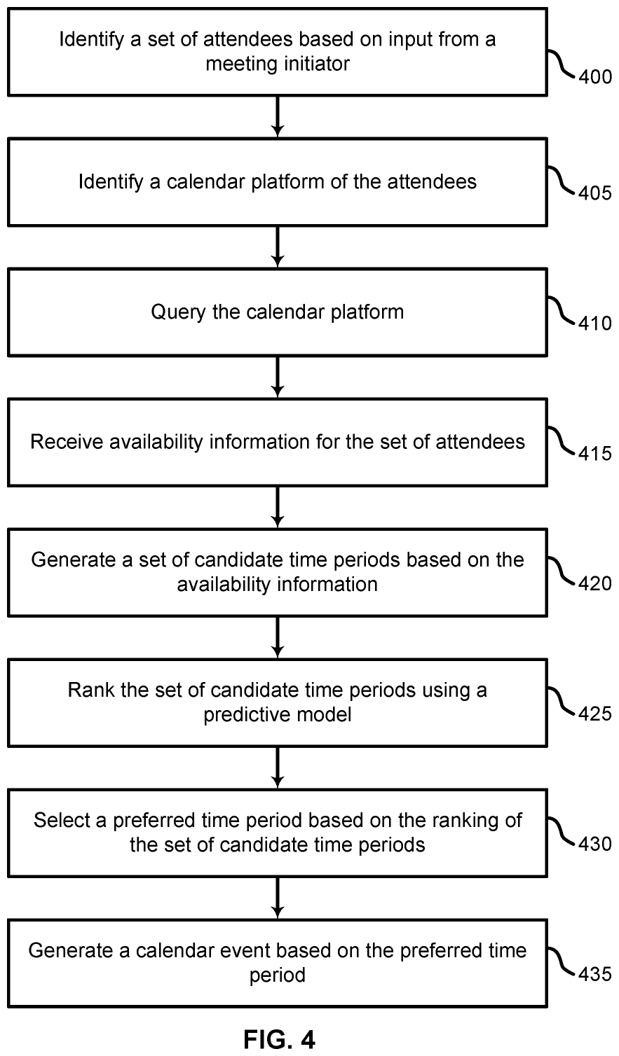

FIG. 4 shows an example of a process for automated calendar coordination based on predictive modeling in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 400, the system identifies a set of attendees based on input from a meeting initiator. In some cases, the operations of this step may refer to, or be performed by, an availability component as described with reference to FIG. 2.

At step 405, the system identifies a calendar platform of the attendees. In some cases, the operations of this step may refer to, or be performed by, an availability component as described with reference to FIG. 2.

At step 410, the system queries the calendar platform. In some cases, the operations of this step may refer to, or be performed by, an availability component as described with reference to FIG. 2.

At step 415, the system receives availability information for the set of attendees. In some cases, the operations of this step may refer to, or be performed by, an availability component as described with reference to FIG. 2.

At step 420, the system generates a set of candidate time periods based on the availability information. In some cases, the operations of this step may refer to, or be performed by, a candidate time component as described with reference to FIG. 2.

At step 425, the system ranks the set of candidate time periods using a predictive model. In some cases, the operations of this step may refer to, or be performed by, a ranking component as described with reference to FIG. 2.

At step 430, the system selects a preferred time period based on the ranking of the set of candidate time periods. In some cases, the operations of this step may refer to, or be performed by, ranking component as described with reference to FIG. 2.

At step 435, the system generates a calendar event based on the preferred time period. In some cases, the operations of this step may refer to, or be performed by, a calendar event component as described with reference to FIG. 2.

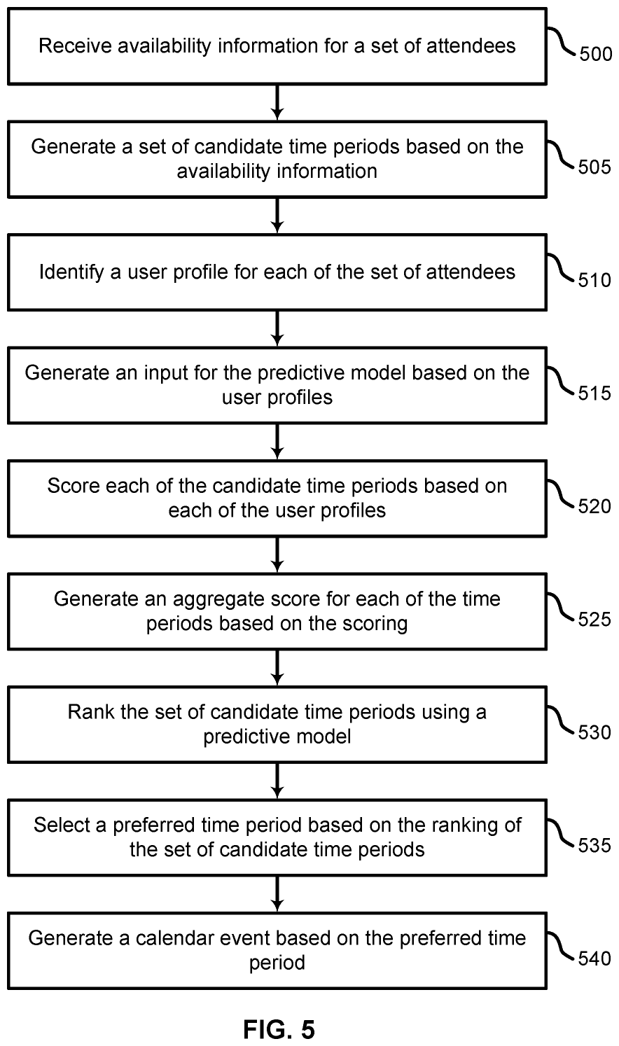

FIG. 5 shows an example of a process for automated calendar coordination based on predictive modeling in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 500, the system receives availability information for a set of attendees. In some cases, the operations of this step may refer to, or be performed by, an availability component as described with reference to FIG. 2.

At step 505, the system generates a set of candidate time periods based on the availability information. In some cases, the operations of this step may refer to, or be performed by, a candidate time component as described with reference to FIG. 2.

At step 510, the system identifies a user profile for each of the set of attendees. In some cases, the operations of this step may refer to, or be performed by, a ranking component as described with reference to FIG. 2.

At step 515, the system generates an input for the predictive model based on the user profiles. In some cases, the operations of this step may refer to, or be performed by, a ranking component as described with reference to FIG. 2.

At step 520, the system scores each of the candidate time periods based on each of the user profiles. In some cases, the operations of this step may refer to, or be performed by, a ranking component as described with reference to FIG. 2.

At step 525, the system generates an aggregate score for each of the time periods based on the scoring. In some cases, the operations of this step may refer to, or be performed by, a ranking component as described with reference to FIG. 2.

At step 530, the system ranks the set of candidate time periods using a predictive model. In some cases, the operations of this step may refer to, or be performed by, a ranking component as described with reference to FIG. 2.

At step 535, the system selects a preferred time period based on the ranking of the set of candidate time periods. In some cases, the operations of this step may refer to, or be performed by, a ranking component as described with reference to FIG. 2.

At step 540, the system generates a calendar event based on the preferred time period. In some cases, the operations of this step may refer to, or be performed by, a calendar event component as described with reference to FIG. 2.

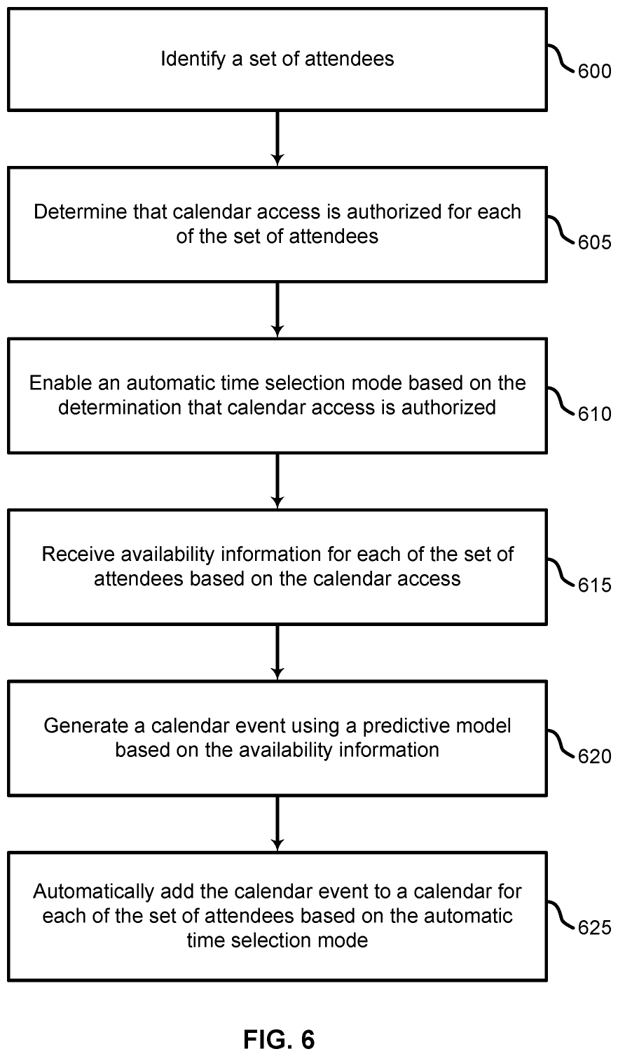

FIG. 6 shows an example of a process for automated calendar coordination based on predictive modeling in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 600, the system identifies a set of attendees. In some cases, the operations of this step may refer to, or be performed by, an availability component as described with reference to FIG. 2.

At step 605, the system determines that calendar access is authorized for each of the set of attendees. In some cases, the operations of this step may refer to, or be performed by, an availability component as described with reference to FIG. 2.

At step 610, the system enables an automatic time selection mode based on the determination that calendar access is authorized. In some cases, the operations of this step may refer to, or be performed by, an availability component as described with reference to FIG. 2.

At step 615, the system receives availability information for each of the set of attendees based on the calendar access. In some cases, the operations of this step may refer to, or be performed by, an availability component as described with reference to FIG. 2.

At step 620, the system generates a calendar event using a predictive model based on the availability information. In some cases, the operations of this step may refer to, or be performed by, a calendar event component as described with reference to FIG. 2.

At step 625, the system automatically adds the calendar event to a calendar for each of the set of attendees based on the automatic time selection mode. In some cases, the operations of this step may refer to, or be performed by, a calendar event component as described with reference to FIG. 2.

Accordingly, the present disclosure includes the following embodiments.

A method for automated calendar coordination based on predictive modeling is described. The method may include receiving availability information for a plurality of attendees, generating a plurality of candidate time periods based on the availability information, ranking the plurality of candidate time periods using a predictive model, selecting a preferred time period based on the ranking of the plurality of candidate time periods, and generating a calendar event based on the preferred time period.

An apparatus for automated calendar coordination based on predictive modeling is described. The apparatus may include a processor, memory in electronic communication with the processor, and instructions stored in the memory. The instructions may be operable to cause the processor to receive availability information for a plurality of attendees, generate a plurality of candidate time periods based on the availability information, rank the plurality of candidate time periods using a predictive model, select a preferred time period based on the ranking of the plurality of candidate time periods, and generate a calendar event based on the preferred time period.

A non-transitory computer readable medium storing code for automated calendar coordination based on predictive modeling is described. In some examples, the code comprises instructions executable by a processor to: receive availability information for a plurality of attendees, generate a plurality of candidate time periods based on the availability information, rank the plurality of candidate time periods using a predictive model, select a preferred time period based on the ranking of the plurality of candidate time periods, and generate a calendar event based on the preferred time period.

Some examples of the method, apparatus, non-transitory computer readable medium, and system described above may further include automatically placing the calendar event on a calendar of each of the plurality of attendees.

Some examples of the method, apparatus, non-transitory computer readable medium, and system described above may further include receiving feedback for the calendar event based on the placement. Some examples may further include selecting an alternative time period based on the feedback and the ranking. Some examples may further include updating the calendar event based on the alternative time period.

Some examples of the method, apparatus, non-transitory computer readable medium, and system described above may further include identifying a set of scheduling rules comprising time of day rules, day of week rules, holiday rules, seasonality rules, a future time threshold, or any combination thereof, wherein the candidate time periods are generated based on the set of scheduling rules.

Some examples of the method, apparatus, non-transitory computer readable medium, and system described above may further include identifying a user profile for each of the plurality of attendees. Some examples may further include generating an input for the predictive model based on the user profiles.

Some examples of the method, apparatus, non-transitory computer readable medium, and system described above may further include scoring each of the candidate time periods based on each of the user profiles. Some examples may further include generating an aggregate score for each of the time periods based on the scoring.

In some examples, the user profile for each of the plurality of attendees comprises personal information, company information, a scheduling history, a hold rate history, a meeting acceptance history, a position, a gender, a time of year, age information, demographic information, weather information, or any combination thereof.

Some examples of the method, apparatus, non-transitory computer readable medium, and system described above may further include receiving meeting acceptance feedback in response to the generated calendar event. Some examples may further include updating the predictive model based on the meeting acceptance feedback.

Some examples of the method, apparatus, non-transitory computer readable medium, and system described above may further include identifying training data based on historical meeting acceptance data. Some examples may further include training the predictive model based on the meeting acceptance data, wherein the predictive model comprises a machine learning model.

Some examples of the method, apparatus, non-transitory computer readable medium, and system described above may further include identifying the plurality of attendees based on input from a meeting initiator. Some examples may further include identifying a calendar platform of the attendees. Some examples may further include querying the calendar platform, wherein at least a portion of the availability information is received in response to the query.

Some examples of the method, apparatus, non-transitory computer readable medium, and system described above may further include determining that at least one of the attendees is associated with an external organization. Some examples may further include identifying an organization coordinator for the external organization.

Some examples of the method, apparatus, non-transitory computer readable medium, and system described above may further include transmitting coordination information to the organization coordinator. Some examples may further include receiving input from the organization coordinator in response to the coordination information, wherein the availability information is received based on the input.

In some examples, at least one of the attendees is identified based on the input from the organization coordinator. In some examples, the input from the organization coordinator includes authorization information for accessing calendar information for at least one of the attendees.

Some examples of the method, apparatus, non-transitory computer readable medium, and system described above may further include determining that at least one of the attendees is an optional attendee, wherein generating the plurality of candidate time periods or ranking the plurality of time periods is based on the determination.

A method for automated calendar coordination based on predictive modeling is described. The method may include identifying a plurality of attendees, determining that calendar access is authorized for each of the plurality of attendees, enabling an automatic time selection mode based on the determination that calendar access is authorized, receiving availability information for each of the plurality of attendees based on the calendar access, generating a calendar event using a predictive model based on the availability information, and automatically adding the calendar event to a calendar for each of the plurality of attendees based on the automatic time selection mode.

An apparatus for automated calendar coordination based on predictive modeling is described. The apparatus may include a processor, memory in electronic communication with the processor, and instructions stored in the memory. The instructions may be operable to cause the processor to identify a plurality of attendees, determine that calendar access is authorized for each of the plurality of attendees, enable an automatic time selection mode based on the determination that calendar access is authorized, receive availability information for each of the plurality of attendees based on the calendar access, generate a calendar event using a predictive model based on the availability information, and automatically add the calendar event to a calendar for each of the plurality of attendees based on the automatic time selection mode.

A non-transitory computer readable medium storing code for automated calendar coordination based on predictive modeling is described. In some examples, the code comprises instructions executable by a processor to: identify a plurality of attendees, determine that calendar access is authorized for each of the plurality of attendees, enable an automatic time selection mode based on the determination that calendar access is authorized, receive availability information for each of the plurality of attendees based on the calendar access, generate a calendar event using a predictive model based on the availability information, and automatically add the calendar event to a calendar for each of the plurality of attendees based on the automatic time selection mode.

In some examples, the determination that calendar access is authorized is based on the plurality of attendees belonging to a same organization.

Some examples of the method, apparatus, non-transitory computer readable medium, and system described above may further include transmitting a calendar connect request. Some examples may further include receiving calendar access for at least one of the plurality of attendees based on the calendar connect request.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media.

For example, if code or data is transmitted from a web site, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.”

What is claimed is:

1. A method for calendar coordination, comprising:
receiving availability information for a plurality of attendees;
generating a plurality of candidate time periods based on the availability information;
ranking the plurality of candidate time periods using a predictive model;
selecting a preferred time period based on the ranking of the plurality of candidate time periods; and
generating a calendar event based on the preferred time period.

2. The method of claim 1, further comprising:
automatically placing the calendar event on a calendar of each of the plurality of attendees.

3. The method of claim 2, further comprising:
receiving feedback for the calendar event based on the placement;
selecting an alternative time period based on the feedback and the ranking; and
updating the calendar event based on the alternative time period.

4. The method of claim 1, further comprising:
identifying a set of scheduling rules comprising time of day rules, day of week rules, holiday rules, seasonality rules, a future time threshold, or any combination thereof, wherein the candidate time periods are generated based on the set of scheduling rules.

5. The method of claim 1, further comprising:
identifying a user profile for each of the plurality of attendees; and
generating an input for the predictive model based on the user profiles.

6. The method of claim 5, further comprising:
scoring each of the candidate time periods based on each of the user profiles; and
generating an aggregate score for each of the time periods based on the scoring.

7. The method of claim 5, wherein:
the user profile for each of the plurality of attendees comprises personal information, company information, a scheduling history, a hold rate history, a meeting acceptance history, a position, a gender, a time of year, age information, demographic information, weather information, or any combination thereof.

8. The method of claim 7, further comprising:
receiving meeting acceptance feedback in response to the generated calendar event; and
updating the predictive model based on the meeting acceptance feedback.

9. The method of claim 1, further comprising:
identifying training data based on historical meeting acceptance data; and
training the predictive model based on the meeting acceptance data, wherein the predictive model comprises a machine learning model.

10. The method of claim 1, further comprising:
identifying the plurality of attendees based on input from a meeting initiator;
identifying a calendar platform of the attendees; and
querying the calendar platform, wherein at least a portion of the availability information is received in response to the query.

11. The method of claim 1, further comprising:
determining that at least one of the attendees is associated with an external organization; and
identifying an organization coordinator for the external organization.

12. The method of claim 11, further comprising:
transmitting coordination information to the organization coordinator; and
receiving input from the organization coordinator in response to the coordination information, wherein the availability information is received based on the input.

13. The method of claim 12, wherein:
at least one of the attendees is identified based on the input from the organization coordinator.

14. The method of claim 12, wherein:
the input from the organization coordinator includes authorization information for accessing calendar information for at least one of the attendees.

15. The method of claim 1, further comprising:
determining that at least one of the attendees is an optional attendee, wherein generating the plurality of candidate time periods or ranking the plurality of time periods is based on the determination.

16. An apparatus for automated calendar coordination based on predictive modeling, comprising: a processor and a memory storing instructions and in electronic communication with the processor, the processor being configured to execute the instructions to:
receive availability information for a plurality of attendees;
generate a plurality of candidate time periods based on the availability information;
rank the plurality of candidate time periods using a predictive model;
select a preferred time period based on the ranking of the plurality of candidate time periods; and
generate a calendar event based on the preferred time period.

17. The apparatus of claim 16, the processor being further configured to execute the instructions to:
determine that at least one of the attendees is associated with an external organization; and
identify an organization coordinator for the external organization.

18. A method for calendar coordination, comprising:
identifying a plurality of attendees;
determining that calendar access is authorized for each of the plurality of attendees;
enabling an automatic time selection mode based on the determination that calendar access is authorized;
receiving availability information for each of the plurality of attendees based on the calendar access;
generating a calendar event using a predictive model based on the availability information; and
automatically adding the calendar event to a calendar for each of the plurality of attendees based on the automatic time selection mode.

19. The method of claim 18, wherein:
the determination that calendar access is authorized is based on the plurality of attendees belonging to a same organization.

20. The method of claim 18, further comprising:
transmitting a calendar connect request; and
receiving calendar access for at least one of the plurality of attendees based on the calendar connect request.
